(19) United States
(12) Patent Application Publication
(10) Pub. No.: US 2026/0008263 A1
(43) Pub. Date: Jan. 8, 2026

(54) MULTICOLOUR PAD PRINTING MACHINE

(71) Applicant: Vineet Jain, Gurugram (IN)

(72) Inventor: Vineet Jain, Gurugram (IN)

(21) Appl. No.: 19/263,342

(22) Filed: Jul. 8, 2025

(30) Foreign Application Priority Data
Jul. 8, 2024 (IN) 202411052257

(51) Int. Cl. B41F 17/00; B41F 31/02; B41F 35/00

(52) U.S. Cl. CPC B41F 17/001; B41F 31/02; B41F 35/00

(57) ABSTRACT

Disclosed is a pad printing machine including a base, a platform, and a plurality of pad printing units. The platform is disposed on the base and is adapted to hold an article for printing. Further, the plurality of pad printing units is disposed on the base at a predetermined orientation with respect to each other. Each of the pad printing units includes a cliché plate, an ink cup, a sliding carriage and a silicon pad assembly. The cliché plate includes a pattern to print on the article. Further, the ink cup is adapted to provide ink to the cliché plate during a sliding operation thereof. Moreover, the sliding carriage is positioned above the cliché plate. Furthermore, the silicon pad assembly is slidably mounted on the sliding carriage and is adapted to slide between a home position and the platform.

### TECHNICAL FIELD

The present invention relates to a pad printing machine. More particularly, the present disclosure relates to a multi colour pad printing machine with a stationary platform and independently movable pad printing units to print intricate and complex designs on an article in different colours.

### BACKGROUND

Pad printing, also known as tampography, is a type of printing that is used to transfer a two-dimensional (2D) image onto a three-dimensional (3D) object. The pad printing implements a printing process, in which a silicone rubber pad transfers an image from a cliché onto an article by doctoring cup. The article can be cutlery, automotive components, promotional items, apparel, labels, electronic goods, sports equipment, toys, and other appliances. Further, the printing ink includes materials like conductive inks, adhesives, dyes, and lubricants, besides special inks.

Conventional pad printing machines are generally limited to monocolour printing of designs on an article. Some of the pad printing machines can print different colours, and multiple pad printing machines are used. In such printing machines, multiple printing stations are employed, and the platform holding the article travels along a path formed along the different printing stations, such that the article receives the imprint at each printing station. Such an operation warrants precise travel and accurate positioning of the platform, resulting in the conventional pad printing machine prone to error. One of the ways to mitigate this issue is to use high-precision equipment and a sensor suite that makes the conventional pad printing machine bulky and complex.

Therefore, in light of the foregoing discussion, a better technology for pad printing machines is required which can solve the aforementioned issues.

### SUMMARY

This summary is provided to introduce a selection of concepts, in a simplified format, that are further described in the detailed description of the invention. This summary is neither intended to identify key or essential inventive concepts of the invention nor intended to determine the scope of the invention.

In an embodiment of the present disclosure, a pad printing machine is disclosed that includes a base, a platform, and a plurality of pad printing units. The platform is disposed on the base and is adapted to hold an article thereon for printing. Further, the plurality of pad printing units is disposed on the base at a predetermined orientation with respect to each other, wherein each of the pad printing units includes a cliché plate, an ink cup, a sliding carriage and a silicon pad assembly. The cliché plate is disposed adjacent to the platform and includes a pattern to print on the article. Further, the ink cup is disposed slidably over the cliché plate and is adapted to provide ink to the cliché plate during a sliding operation thereof. Moreover, the sliding carriage is positioned above the cliché plate. Furthermore, the silicon pad assembly is slidably mounted on the sliding carriage and is adapted to slide between a home position and the platform. The silicon pad is adapted to make selective contact with the cliché plate at the home position to pick up the ink therefrom. Further, the silicon pad assembly is adapted to make selective contact with the platform to deposit the ink on the article.

According to the present disclosure, the presence of the plurality of pad printing units and simultaneously printing by the plurality of pad printing units increases the overall speed of the printing processes. In addition, more complex and intricate designs having different colours can be printed by the pad printing machine. Also, multiple platforms are not required to print intricate and multi-colour patterns, thereby reducing the space requirement of the pad printing machine.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a pad printing machine is shown, in accordance with an embodiment of the present disclosure;

FIG. 2 illustrates a back-perspective view of the pad printing machine without the cover is shown, in accordance with an embodiment of the present disclosure;

FIG. 3 illustrates a top view of the pad printing machine without the cover is shown, in accordance with an embodiment of the present disclosure;

FIG. 4A illustrates an actuation of a first carriage assembly to facilitate the printing via a first pad assembly, is shown, in accordance with an embodiment of the present disclosure;

FIG. 4B illustrates a line diagram of the actuation of the first carriage assembly to perform a first printing operation, in accordance with an embodiment of the present disclosure;

FIG. 5A illustrates an actuation of a third carriage assembly to facilitate the printing via a third pad assembly, is shown, in accordance with an embodiment of the present disclosure;

FIG. 5B illustrates a line diagram of the actuation of the third carriage assembly to perform a third printing operation, in accordance with an embodiment of the present disclosure;

FIG. 6A illustrates an actuation of a second carriage assembly to facilitate the printing via a second pad assembly is shown, in accordance with an embodiment of the present disclosure; and

FIG. 6B illustrates a line diagram of the actuation of the second carriage assembly to perform a second printing operation, in accordance with an embodiment of the present disclosure.

Further, skilled artisans will appreciate that elements in the drawings are illustrated for simplicity and cannot have necessarily been drawn to scale.

Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The system, methods, and examples provided herein are illustrative only and not intended to be limiting.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein are for describing, teaching and illuminating some embodiments and their specific features and elements and do not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” “one or more elements” “at least one feature” or “at least one element.” Furthermore, the use of the terms “one or more” or “at least one” feature or element does NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having an ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfil the requirements of uniqueness, utility, and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “a further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any feature and/or element described in the context of separate embodiments may alternatively be realized as existing together in the context of a single embodiment.

Any particular and all details set forth herein are used in the context of some embodiments and therefore should NOT be necessarily taken as limiting factors to the attached claims. The attached claims and their legal equivalents can be realized in the context of embodiments other than the ones used as illustrative examples in the description below.

Embodiments of the present disclosure will be described below in detail with reference to the accompanying drawings.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

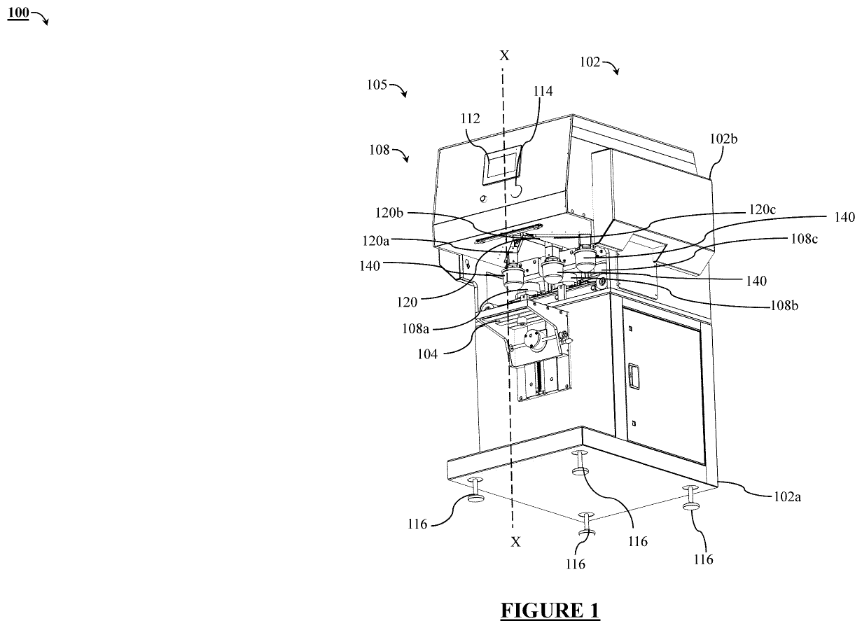

FIG. 1 illustrates a pad printing machine 100 is shown, in accordance with an embodiment of the present disclosure. The pad printing machine 100 is a printing apparatus which may be used for transferring intricate two-dimensional (2D) images onto three-dimensional (3D) articles using a pad printing operation. The pad printing operation can be used for printing on irregular, curved, or textured surfaces where other printing methods may not work well. The pad printing machine 100 of the present disclosure is capable of producing high-quality multi-colour printed articles as a position of the article remains stationary during the printing process. The stationary position of the articles provides high printing accuracy using the pad printing machine 100. Moreover, the printing process in the pad printing machine 100 is quicker than the printing process performed by currently known multi-colour pad printing process. This is achieved by enabling execution of simultaneous sub-operation of the printing process, thereby making the pad printing machine 100 quicker. In addition, the pad printing machine 100 is a compact unit while being quicker.

The pad printing machine 100 includes, but is not limited to, a base 102, a platform 104, and a plurality of pad printing units 105 to facilitate the printing on an article. In addition, each of the plurality of pad printing units 105 includes but are not limited to an ink cup 108, a cliché plate 106, a sliding carriage 130, and a silicon pad assembly 110. Also, the pad printing machine 100 includes a Human-Machine Interface (HMI) screen 112 and a plurality of buttons 114 to facilitate the actuation of the pad printing machine 100. In an embodiment, the article can include cutlery, automotive components, promotional items, apparel, labels, electronic goods, sports equipment, toys, and other appliances.

The base 102 of the pad printing machine 100 provides a sturdy support and facilitates the installation of the components of the pad printing machine 100 thereon, as the base 102 acts as a housing for the pad printing machine 100. The base 102 can be defined in an L-shaped configuration, which can be adapted to accommodate the components of the pad printing machine 100. The base 102 is mounted on a set of four legs 116, which is used to place the pad printing machine 100 on the floor and prevent any fault conditions that can arise due to the pad printing machine 100 being directly on the floor.

The base 102 of the pad printing machine 100 includes a bottom cover 102a to facilitate the positioning of the plurality of pad printing units 105 on the bottom cover 102a of the base 102. In addition, the base 102 also includes a top cover 102b to facilitate the covering of the plurality of pad printing units 105 and define an enclosure for the plurality of pad printing units 105. In an embodiment, the top cover 102b extends from a top to a bottom of the pad printing machine 100.

In an embodiment, the base 102 of the pad printing machine 100 defines a table pedestal stand to facilitate the positioning of the pad printing machine 100 on a table. In another embodiment, the base 102 of the pad printing machine 100 defines a high pedestal stand to facilitate the position of the pad printing machine on the ground and position the pad printing machine 100 at a height from the ground/floor.

Further, the top cover 102b of the base 102 of the pad printing machine 100 includes a plurality of slots 120 to facilitate the positioning and the movement of the plurality of pad printing units 105 when the printing is determined by the plurality of pad printing units 105. In the illustrated embodiment, the base 102 includes, but is not limited to a first slot 120a extending diagonally on the base 102, a second slot 120b extending longitudinally along a width of the base 102, and a third slot 120c extending diagonally on the base 102 and spaced apart from the second slot 120b. In an example, the first slot 120a, the second slot 120b, the third slot 120c are disposed substantially at a predefined angle from one other as shown in FIG. 1. In another example, the first slot 120a and the third slot 120c of the base 102 are disposed substantially perpendicularly to one other.

The platform 104 is disposed on the base 102 and is adapted to hold an article thereon for printing. In one example, the platform 104 is mounted on the bottom cover 102a of the pad printing machine 100. Further, the mount for the platform 104 includes a set of handles (not shown) that are used to adjust and lock position of the platform 104 with respect to the pad printing machine 100. During the operation, the set of handles facilitates movement of the platform 104 along a height and a width of the pad printing machine 100, along with the distance from or towards the pad printing machine 100 for accurate positioning.

In addition, the pad printing machine 100 includes the HMI screen 112 is installed on a front-top portion of the base 102, which serves as a Human-Machine Interface (HMI) and displays the information related to the operations of the pad printing machine 100. The HMI screen 112 is coupled with a control unit (not shown), which is configured to incorporate a plate and pad life counter. The control unit of the pad printing machine 100 is adapted to operate the plurality of pad printing units 105 in a predefined sequence, which are adapted to print on the article. Further, the plurality of buttons 114 can be used to control the settings and operation of the pad printing machine 100. The plurality of buttons 114 has one of the normal buttons to operate the machine or an emergency stop button, which is used to stop the pad printing machine 100 under fault conditions.

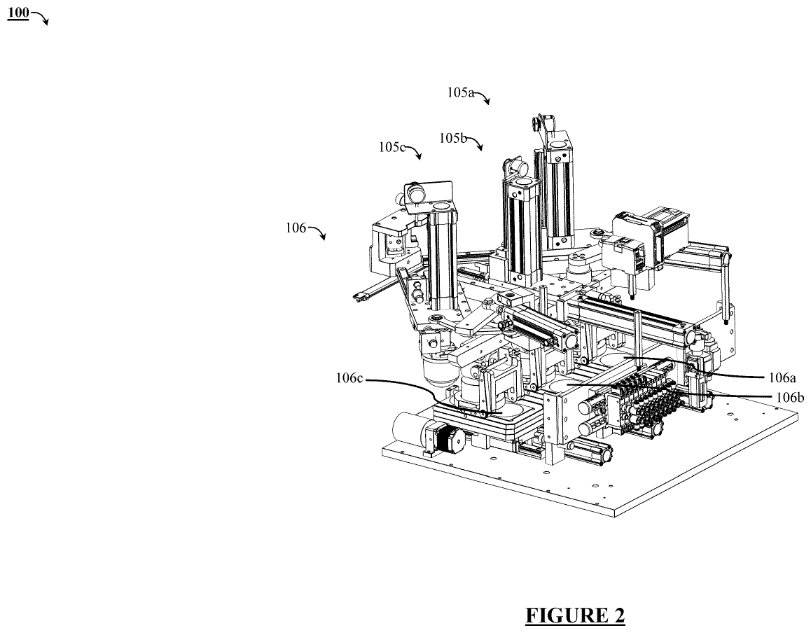

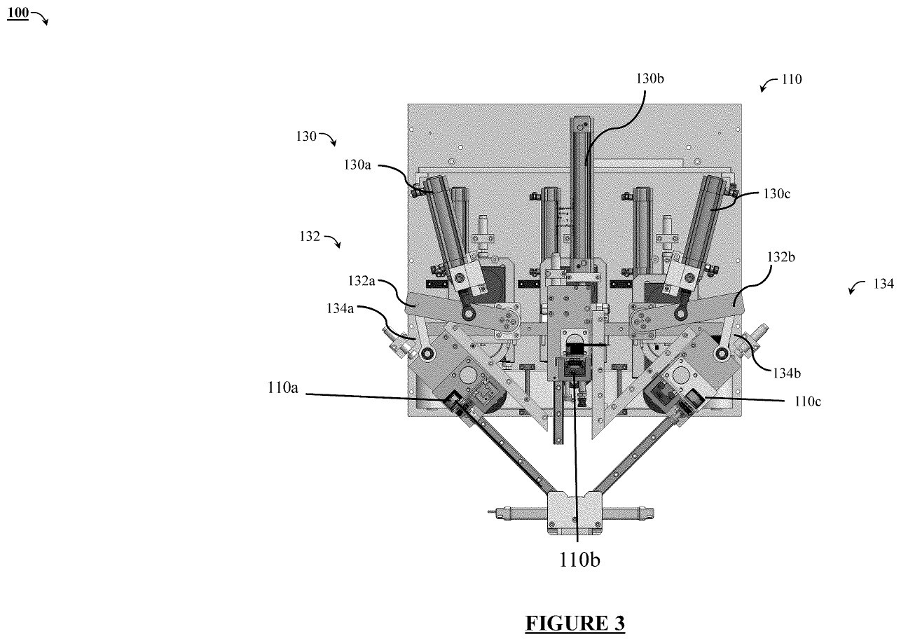

FIG. 2 illustrates a back-perspective view of the pad printing machine 100 without the top cover 102b is shown, in accordance with an embodiment of the present disclosure. FIG. 3 illustrates a top view of the pad printing machine 100 without the top cover 102b is shown, in accordance with an embodiment of the present disclosure. For the sake of brevity, FIG. 2 and FIG. 3 have been explained together.

As shown in FIG. 2 and FIG. 3, the plurality of pad printing units 105 is disposed on the base 102 at a predetermined orientation with respect to each other. Further, the plurality of pad printing units 105 is adapted to print on the article sequentially to improve the printing operation and subsequently reduce the production time. The plurality of pad printing units 105 includes a first pad printing unit 105a, a second pad printing unit 105b, and a third pad printing unit 105c. The second printing unit 105b is positioned at a first predefined angle from the first pad printing unit 105a and the third pad printing unit 105c is positioned at a second predefined angle from the second pad printing unit 105b. Further, the first predefined angle and the second predefined angle can be between 30 to 90 degrees. Moreover, each of the plurality of pad printing units 105 includes, but is not limited to, the ink cup 108, the cliché plates 106, the actuator 130, and the silicon pad assembly 110.

In an embodiment, the plurality of pad printing units 105 can be adapted to operate in a mono-colour mode, a dual-colour mode, and tri-colour mode.

In another embodiment, the plurality of pad printing units 105 can be arranged in a manner such that, the first pad printing unit 105a, the second pad printing unit 105b, and the third pad printing unit 105c are adapted to be positioned at the first predefined angle and the second predefined angle, respectively.

As shown in FIG. 2 and FIG. 3, the cliché plate 106 can be disposed adjacent to the platform 104 and which includes a pattern to print on the article. The cliché plate 106 is a plate etched with an artwork which can be printed onto the article. Further, the cliché plate 106 can be removably attached to the pad printing machine 100, and the cliché plate 106 includes different designs, different etching, different shapes, and configurations based on the printing to be performed on the article.

The cliché plates 106 include, but are not limited to, a first cliché plate 106a, a second cliché plate 106b, and a third cliché plate 106c. The first cliché plate 106a is a part of the first pad printing unit 105a, which is disposed spaced apart from the platform 104 and is coupled with a first ink cup 108a. Further, the second cliché plate 106b is a part of the second pad printing unit 105b, which is disposed spaced apart from the platform 104 adapted to be coupled with a second ink cup 108b. Similarly, the third cliché plate 106c is a part of the third pad printing unit 105c, which is disposed spaced apart from the platform 104 adapted to be coupled with a third ink cup 108c. In an embodiment, the three cliché plates 106a, 106b, 106c can have different designs, which may be required for printing on the article.

In addition, the ink cup 108 can be disposed slidably over the cliché plate 106 and adapted to provide ink to the cliché plate 106 during a sliding operation thereof. The ink cup 108 spreads the ink onto the entire surface of the cliche plate 106 and further removes the excess ink from the cliche plate 106 only leaving the ink in an etched crevices of the cliché plate 106. The ink cups 108 are non-magnetic ink cups incorporated with a heat sink to overcome heating issues associated with the ink cups 108. In an embodiment, the ink cups can include the first ink cup 108a, the second ink cup 108b, and the third ink cup 108c. The first ink cup 108a is a part of the first pad printing unit 105a and is slidably disposed on the first cliché plate 106a. Similarly, the second ink cup 108b is a part of the second pad printing unit 105b and slidably disposed on the second cliche plate 106b and is a part of the second pad printing unit 105b. The third ink cup 108c is a part of the third pad printing unit 105c and is slidably disposed on the third cliché plate 106c. In an embodiment, the ink cups 108a, 108b, 108c can be supplied with different colours which can be used for the printing on the article.

In addition, the actuator 130 is positioned above the cliché plate 106 and is pivotally coupled with the base 102 along a respective central portion and adapted to move in an extended position and a retracted position. In an example, in an extended position of the one of the actuators 130 of the pad printing machine 100 facilitates the printing on the article.

In addition, the actuator 130 includes a first actuator 130a, a second actuator 130b, and the third actuator 130c. In an embodiment, the actuators 130 include, but are not limited to, a pneumatic piston-cylinder arrangement, a hydraulic piston-cylinder arrangement, a motor-based four-bar mechanism, or any other arrangement known in the art.

The first actuator 130a is a part of the first pad printing unit 105a, the second actuator 130b is a part of the second pad printing unit 105b, and the third actuator 130c is a part of the third pad printing unit 105c.

Further, the plurality of pad printing units 105 includes a plurality of levers 132 pivotally coupled with the actuators 130. The plurality of lever 132 facilitates leveraging the motion of the actuators 130. The plurality of lever 132 is pivotably coupled with a portion of the base 102. The plurality of lever 132 may include a first lever 132a, and a second lever 132b. In an illustrated embodiment, the first lever 132a is pivotally coupled with the base 102 and having a first end coupled with the first actuator 130a. Further, the second lever 132b is pivotally coupled with the base 102 and having a first end coupled with the third actuator 130c.

Additionally, the plurality of pad printing units 105 includes a plurality of connecting rod 134 to facilitate the coupling of the plurality of lever 132 with the silicon pad assemblies 110. The plurality of connecting rod 134 may include a first connecting rod 134a, and a second connecting rod 134b. In an embodiment, the first connecting rod 134a is adapted to couple the first lever 132a and a first silicon pad assembly 110a. Similarly, the second connecting rod 134b is adapted to couple the second lever 132b with a third silicon pad assembly 110c. While second silicon pad assembly 110b is directly coupled with actuator 130b.

Further, the silicon pad assembly 110 can be slidably mounted on the actuators 130 and adapted to slide between a home position and the platform 104. The silicon pad assembly 110 can be adapted to make selective contact with the cliché plate 106 at the home position to pick the ink therefrom and make selective contact with the platform 104 to deposit the ink on the article. In addition, the each of the silicon pad assembly 110 includes a silicon pad 140 coupled with the silicon pad assembly 110 and is adapted to move along a vertical axis (X-X) of the pad printing machine 100, and the silicon pad assembly 110 of each of the plurality of pad printing units 105 has a sliding path independent from other silicon pad assembly 110. The silicone pad 140 on each of the silicon pad assemblies 110 is used to transfer the ink from the each of the cliche plate 106 to the article. In an embodiment, the silicone pad 140 includes a plurality of silicone pads which differ in shape and size based on the size of the article.

Furthermore, the silicon pad assembly 110 is used to selectively make contact with the cliché plate 106 to pick the ink there from. As an example, the first silicon pad assembly 110a is disposed within the first slot 120a of the base 102 and is used to move relative to the first cliché plate 106a and the platform 104. In addition, the second silicon pad assembly 110b is disposed within the second slot 120b of the base 102 and is used to move relative to the second cliché plate 106b and the platform 104. Similarly, the third silicon pad assembly 110c is disposed within the third slot 120b of the base 102 and is used to move relative to the third cliché plate 106c and the platform 104.

In an embodiment, each silicon pad assembly 110 of the plurality of pad printing unit 105, at the platform 104, is adapted to exhibit a pad stroke between a top position and the article, and where a length of the stroke of the silicon pads 140 of the plurality of pad printing unit 105 is independently adjustable.

In another embodiment, the silicon pad assembly 110 of each of the plurality of pad printing units 105 can be adapted to operate at a predefined pad pressure, where the pad pressure of each of the silicon pad assemblies 110 can be adjusted independently.

In yet another embodiment, the plurality of pad printing units 105 includes but is not limited to an in-built tape cleaning mechanism adapted to clean the silicon pads assembly 110 of the plurality of pad printing units 105.

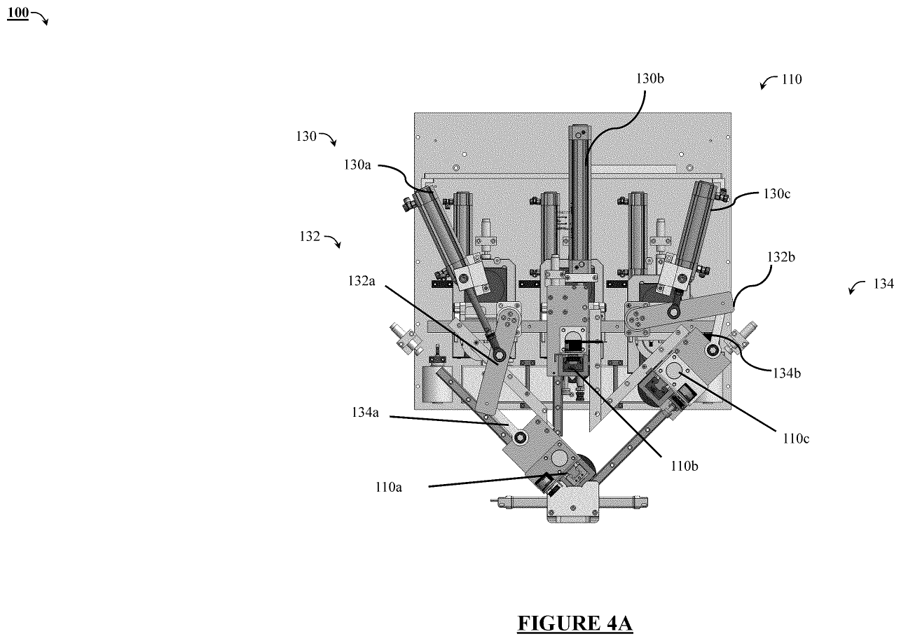

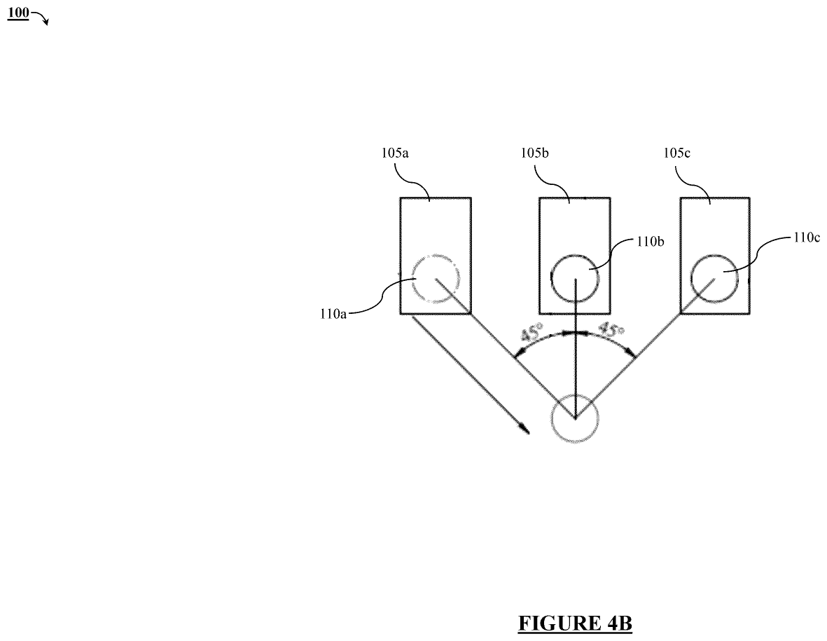

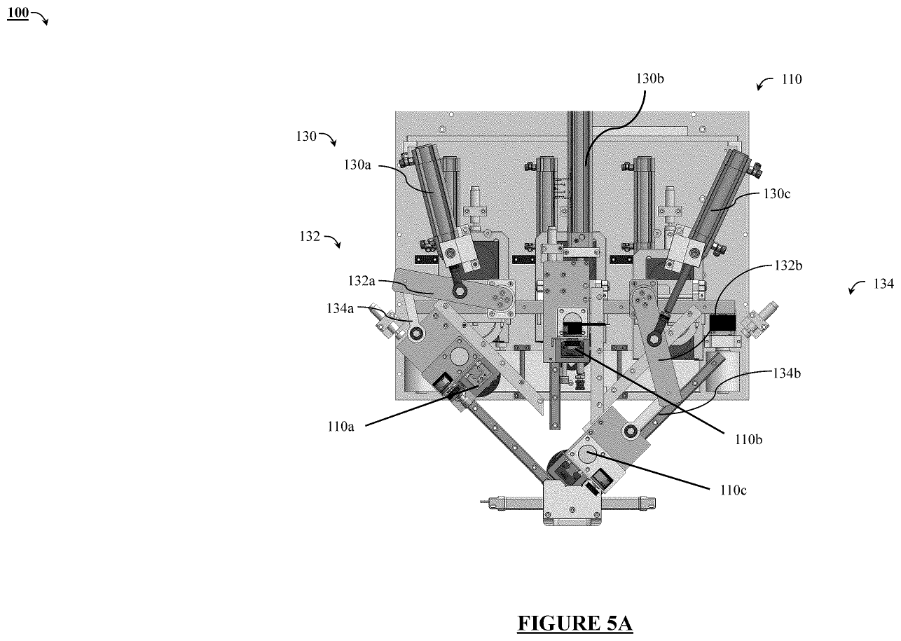

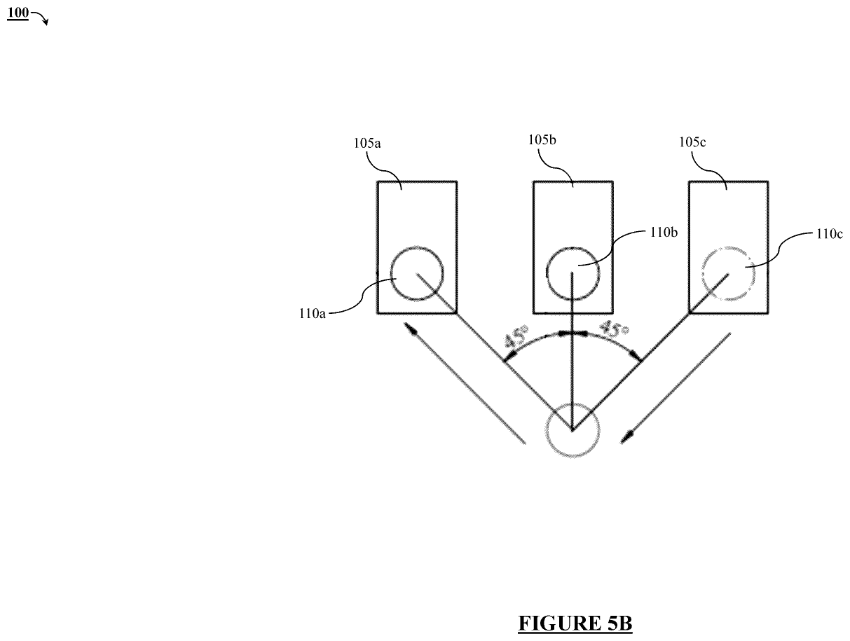

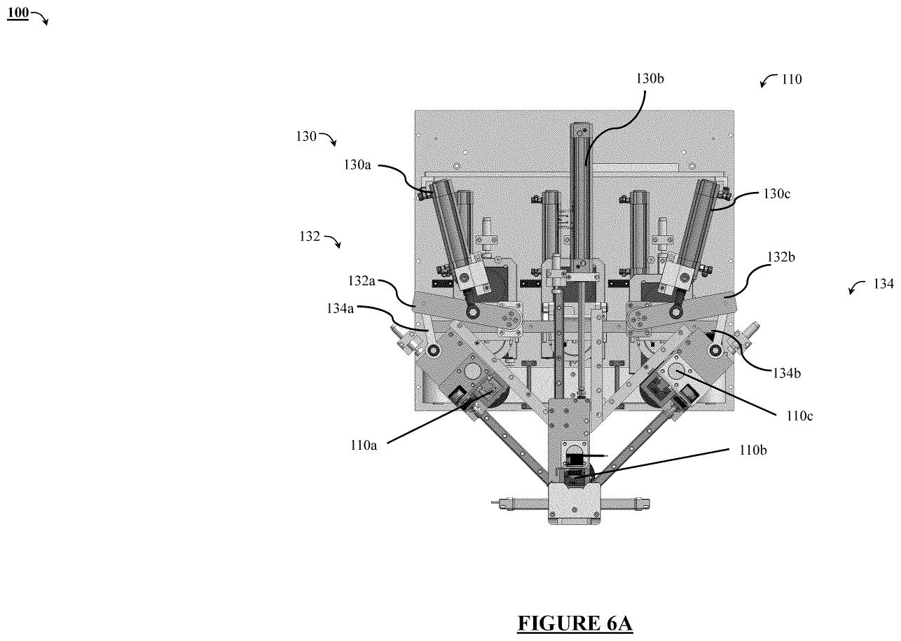

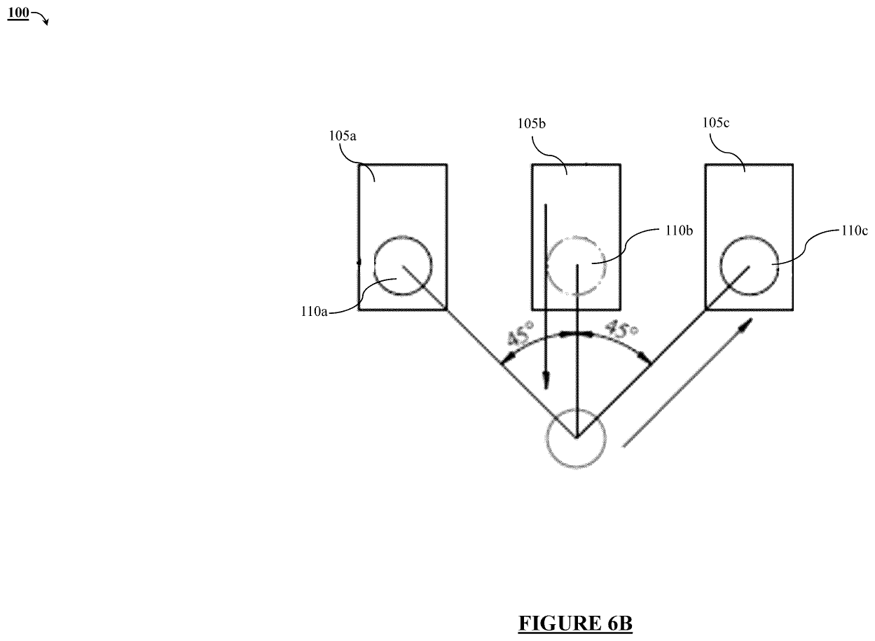

FIG. 4A illustrates an actuation of a first carriage assembly to facilitate the printing via a first pad assembly is shown, in accordance with an embodiment of the present disclosure. FIG. 4B illustrates a line diagram of the actuation of the first carriage assembly to perform a first printing operation, in accordance with an embodiment of the present disclosure. FIG. 5A illustrates an actuation of a third carriage assembly to facilitate the printing via a third pad assembly is shown, in accordance with an embodiment of the present disclosure. FIG. 5B illustrates a line diagram of the actuation of the third carriage assembly to perform a third printing operation, in accordance with an embodiment of the present disclosure. FIG. 6A illustrates an actuation of a second carriage assembly to facilitate the printing via a second pad assembly is shown, in accordance with an embodiment of the present disclosure. FIG. 6B illustrates a line diagram of the actuation of the second carriage assembly to perform a second printing operation, in accordance with an embodiment of the present disclosure. For the sake of brevity, FIG. 4A to FIG. 6B have been explained together. Referring to FIG. 4A to FIG. 6B, the working of the pad printing machine 100 is explained. Each of the plurality of pad printing units 105 is adapted to function independently to perform first, second, and third printing operations using the control unit.

As shown in FIG. 4A and FIG. 4B, the control unit performs the first printing operation adapted to operate the first pad printing unit 105a. The control unit actuates the first actuator 130a to move the first sliding carriage in an extended position. The first lever 132a rotates in response to the extension of the first actuator 130a, thereby extending the first connecting rod 134a and the first silicon pad assembly 110a towards the platform 104. Upon reaching the platform 104, the silicon pad 140 is actuated towards the article that is vertically downwards, and the printing is performed. The first actuator 130a is then moved to a retracted position and is positioned above the first cliché plate 106a.

While the first actuator 130a is moving toward platform 104, the second actuator 130b and the third actuator 130c are disposed in the retracted position. Also, the third ink cup 108c spreads ink on the third cliché plate 106c and silicon pads 140 of the third actuator 130c is actuated downwards towards the cliché plates 106c to enable the collection of the ink and the determined printing pattern on the respective silicon pad 140.

Additionally, as first actuator 130a is moving to a retracted position, the third actuator 130c starts moving towards the printing platform 104, and the second ink cup 108b spreads ink on the second cliché plate 106b. The aforementioned simultaneous actuation reduces the time period between consecutive printing processes, thereby facilitating an increase in the overall speed of the printing. In addition, a more variable printing pattern can be achieved, and different colours can be used for the printing.

As shown in FIG. 5A and FIG. 5B, the control unit performs the second printing operation adapted to operate the third pad printing unit. The control unit actuates the third actuator 130c to move the third sliding carriage in an extended position. The second lever 132b rotates in response to the extension of the third actuator 130c, thereby extending the second connecting rod 134b and the third silicon pad assembly 110c towards the platform 104. Upon reaching the platform 104, the silicon pad 140 is actuated towards the article that is vertically downward, and the printing is performed. The third actuator 130c is then moved to a retracted position and is positioned above the third cliché plate 106c.

While the third actuator 130c is moving toward platform 104, the first actuator 130a and the second actuator 130b are disposed in the retracted position. Also, the second ink cup 108b spreads ink on the second cliché plate 106b and silicon pads 140 of the second actuator 130b are actuated downwards towards the cliché plates 106b to enable the collection of the ink and the determined printing pattern on the respective silicon pad 140.

Additionally, when third actuator 130c is moving to the retracted position, the second actuator 130b is moving toward printing platform 104, and the first ink cup 108a spreads ink on the first cliché plate 106a. The aforementioned simultaneous actuation facilitates increasing the overall speed of the printing. In addition, a more variable printing pattern can be achieved, and different colours can be used for the printing.

As shown in FIG. 6A and FIG. 6B, the control unit performs the third printing operation adapted to operate the second pad printing unit 105b. The control unit actuates the second actuator 130b to move the second sliding carriage in an extended position which further moves the second silicon pad assembly 110b towards platform 104. Upon reaching the platform 104, the silicon pad 140 is actuated towards the article that is vertically downward and the printing is performed. The second sliding carriage is then moved to a retracted position and is positioned above the second cliché plate 106b.

While the second actuator 130b is moving toward platform 104, the first actuator 130a and the third actuator 130c are disposed in the retracted position. Also, the first ink cup 108a spreads ink on the second cliché plate 106a and silicon pads 140 of the first actuator 130a is actuated downwards towards the cliche plates 106a to enable the collection of the ink and the determined printing pattern on the respective silicon pad 140.

Additionally, when second actuator 130b is moving to the retracted position, the first actuator 130a is moving toward printing platform 104, and the third ink cup 108c spreads ink on the first cliché plate 106c. The aforementioned simultaneous actuation facilitates increasing the overall speed of the printing. In addition, a more variable printing pattern can be achieved, and different colours can be used for the printing.

In an embodiment, the silicon pad assembly 110 of the first pad printing unit 105a is adapted to deposit ink of a first colour, the silicon pad assembly 110 of the second pad printing unit 105b is adapted to deposit ink of a second colour, and the silicon pad assembly 110 of the third pad printing unit 105c adapted to deposit ink of a third colour. In such an instance, the first colour, the second colour, and the third colour are one of the same and different. Further, the silicon pad assembly 110 of the first pad printing unit 105a is adapted to deposit ink of a first pattern, the silicon pad assembly 110 of the second pad printing unit 105b adapted to deposit ink of a second pattern, and the silicon pad assembly 110 of the third pad printing unit 105c adapted to deposit ink of a third pattern, wherein the first pattern, the second pattern, and the third pattern is one of same and different.

In another embodiment, the sliding of the silicon pad assembly 110 of the first pad printing unit 105a between the respective home position and the platform 104 is simultaneous to the sliding of the silicon pad assembly 110 of the third pad printing unit 105c between the respective home position and the platform 104.

According to this disclosure, the presence of three pad assemblies 110a, 110b, 110c and simultaneously printing by the three pad assemblies 110a, 110b, 110c increases the overall speed of the printing processes. In addition, more complex and intricate designs having different colours can be printed by the pad printing machine 100. Also, multiple platforms are not required to print intricate and multi-colour patterns thereby reducing the space requirement of the pad printing machine 100. The pad printing machine 100 takes less space, and the space occupied is less compared to the previous designs having multiple platforms or movable platforms. Also, printing and filling of the colours can be simultaneously performed by the pad printing machine 100. Also, the actuator 130 having a pneumatic-based arrangement facilitates precise motion of the three pad assemblies 110a, 110b, 110c and no movement of the article. In this manner, a good quality and accurate print is printed on the article.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

We claim:

1. A pad printing machine comprising:
a base;
a platform disposed on the base, and adapted to hold an article thereon for printing;
a plurality of pad printing units disposed on the base at a predetermined orientation with respect to each other, wherein each of the pad printing units comprises:
a cliché plate disposed adjacent to the platform and comprising a pattern to print on the article;
an ink cup disposed slidably over the cliché plate and adapted to provide ink to the cliché plate during a sliding operation thereof;
an actuator positioned above the cliché plate; and
a silicon pad assembly slidably mounted on the actuator and adapted to slide between a home position and the platform, wherein the silicon pad assembly is adapted to:
make selective contact with the cliché plate at the home position to pick the ink therefrom; and
make selective contact with the platform to deposit the ink on the article.

2. The pad printing machine as claimed in claim 1, wherein the silicon pad assembly of each of the plurality of pad printing units has a sliding path independent from other silicon pad assembly.

3. The pad printing machine as claimed in claim 1, wherein the plurality of pad printing units comprising:
a first pad printing unit;
a second printing unit positioned at a first predefined angle from the first pad printing unit; and
a third pad printing unit positioned at a second predefined angle from the second pad printing unit.

4. The pad printing machine as claimed in claim 3, wherein the first predefined angle and the second predefined angle are between 30 to 90 degrees.

5. The pad printing machine as claimed in claim 3, wherein the silicon pad assembly of the first pad printing unit adapted to deposit ink of a first colour, the silicon pad assembly of the second pad printing unit adapted to deposit ink of a second colour, and the silicon pad assembly of the third pad printing unit adapted to deposit ink of a third colour, wherein the first colour, the second colour, and the third colour is one of same and different.

6. The pad printing machine as claimed in claim 3, wherein the silicon pad assembly of the first pad printing unit adapted to deposit ink of a first pattern, the silicon pad assembly of the second pad printing unit adapted to deposit ink of a second pattern, and the silicon pad assembly of the third pad printing unit adapted to deposit ink of a third pattern, wherein the first pattern, the second pattern, and the third pattern is one of same and different.

7. The pad printing machine as claimed in claim 3, wherein the sliding of the silicon pad assembly of the first pad printing unit between the respective home position and the platform is simultaneous to the sliding of the silicon pad assembly of the third pad printing unit between the respective home position and the platform.

8. The pad printing machine as claimed in claim 1, wherein each of the plurality of pad printing units adapted to function independently to perform first, second, and third printing operations.

9. The pad printing machine as claimed in claim 3, comprising a control unit adapted to operate the plurality of pad printing units in a predefined sequence, wherein the predefined sequence includes at least one of:
a first printing operation adapted to operate the first pad printing unit;
a second printing operation adapted to operate the third pad printing unit; and
a third printing operation adapted to operate the second pad printing unit.

10. The pad printing machine as claimed in claim 1, wherein the plurality of pad printing units is adapted to operate in mono-colour mode, a dual-colour mode, and tri-colour mode.

11. The pad printing machine as claimed in claims 1 and 8, wherein the silicon pad assembly of each of the plurality of pad printing units adapted to operate at a predefined pad pressure, wherein the pad pressure of each of the silicon pad assembly adapted to be adjusted independently.

12. The pad printing machine as claimed in claim 1, wherein each silicon pad assembly of the plurality of pad printing unit, at the platform, is adapted to exhibit a pad stroke between a top position and the article, and wherein a length of the stroke of the silicon pads of the plurality of pad printing unit is independently adjustable.

13. The pad printing machine as claimed in claim 1, wherein the plurality of pad printing units comprising an in-built tape cleaning mechanism adapted to clean the silicon pads assembly of the plurality of pad printing units.
